(19) United States
(12) Patent Application Publication
(10) Pub. No.: US 2022/0059122 A1
(43) Pub. Date: Feb. 24, 2022

(54) PROVIDING EMOTION MANAGEMENT ASSISTANCE

(71) Applicant: Microsoft Technology Licensing, LLC, Redmond, WA (US)

(72) Inventors: Chi Xiu, Beijing (CN); Jian LUAN, Beijing (CN)

(21) Appl. No.: 17/432,476

(22) PCT Filed: Feb. 3, 2020
(86) PCT No.: PCT/US2020/016303

§ 371 Date: Aug. 19, 2021

(30) Foreign Application Priority Data
Mar. 15, 2019 (CN) 201910199122.0

(51) Int. Cl. G10L 25/63; G10L 17/02; G10L 17/04; G10L 17/22

(52) U.S. Cl. CPC G10L 25/63; G10L 17/22; G10L 17/04; G10L 17/02

(57) ABSTRACT

A method for providing emotion management assistance is provided. Sound streams may be received. A speech conversation between a user and at least one conversation object may be detected from the sound streams. Identity of the conversation object may be identified at least according to speech of the conversation object in the speech conversation. Emotion state of at least one speech segment of the user in the speech conversation may be determined. An emotion record corresponding to the speech conversation may be generated, wherein the emotion record at least including the identity of the conversation object, at least a portion of content of the speech conversation, and the emotion state of the at least one speech segment of the user.

### BACKGROUND

Emotion refers to the attitude towards external things that comes with the process of cognition and consciousness, which is the response to the relationship between objective things and the needs of the subject, and a psychological activity that is mediated by the wishes and needs of individuals. Emotion management is very important for human beings, because bad emotions can have adverse effects on human body health, life and work. Emotion management is the process of perceiving, controlling, and regulating the emotions of individuals and groups, which ensures that individuals and groups maintain good emotion states by conducting research on the awareness, coordination, guidance, interaction and control of individuals and groups on their own emotions and the emotions of others, thereby producing a good management effect. For individuals, emotion management can be performed by observing their own emotions, appropriately expressing their own emotions, and releasing emotions in an appropriate manner.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter.

An embodiment of the disclosure proposes a method for providing emotion management assistance. In the method, sound streams may be received. A speech conversation between a user and at least one conversation object may be detected from the sound streams. Identity of the conversation object may be identified at least according to speech of the conversation object in the speech conversation. Emotion state of at least one speech segment of the user in the speech conversation may be determined. An emotion record corresponding to the speech conversation may be generated, wherein the emotion record at least including the identity of the conversation object, at least a portion of content of the speech conversation, and the emotion state of the at least one speech segment of the user.

It should be noted that the above one or more aspects include the following detailed description and features specifically pointed out in the claims. The following description and the appended drawings set forth in detail certain illustrative features of the one or more aspects. These features are merely indicative of various ways in which the principles of the various aspects may be practiced, and the disclosure is intended to include all such aspects and equivalent transformations thereof.

### BRIEF DESCRIPTION OF THE DRAWINGS

The disclosed aspects will hereinafter be described in connection with the appended drawings that are provided to illustrate and not to limit the disclosed aspects.

FIG. 1 illustrates architecture of an exemplary emotion management assistance system according to an embodiment.

FIG. 2 illustrates an exemplary signal processing process according to an embodiment.

FIG. 3 illustrates an exemplary emotion analysis process according to an embodiment.

FIG. 4 illustrates an exemplary emotion attention point determining process according to an embodiment.

FIG. 5 illustrates an exemplary emotion record generating process according to an embodiment.

FIG. 6 is a flowchart of an exemplary method for providing emotion management assistance according to an embodiment.

FIG. 7 illustrates an exemplary interface for displaying a list of emotion records according to an embodiment.

FIG. 8 illustrates an exemplary interface for displaying an emotion record according to an embodiment.

FIG. 9 illustrates an exemplary overall emotion state in chart form according to an embodiment.

FIG. 10 illustrates an exemplary interface for displaying a list of emotion statistics according to an embodiment.

FIG. 11A-11B illustrate exemplary staged emotion states of a user in different predetermined periods according to an embodiment.

FIG. 12 is an exemplary statistical chart of staged change of each emotion type in a plurality of predetermined periods according to an embodiment.

FIG. 13 is an exemplary statistical chart of staged emotion state change in a plurality of predetermined periods according to an embodiment.

FIG. 14 is an exemplary emotion state statistical chart and an exemplary list of emotion records for different conversation objects according to an embodiment.

FIG. 15 illustrates a flowchart of an exemplary method for providing emotion management assistance according to an embodiment.

FIG. 16 illustrates an exemplary apparatus for providing emotion management assistance according to an embodiment.

FIG. 17 illustrates another exemplary apparatus for providing emotion management assistance according to an embodiment.

### DETAILED DESCRIPTION

The present disclosure will now be discussed with reference to various exemplary embodiments. It should be understood that the discussion of the embodiments is merely intended to enable a person skilled in the art to understand better and thus practice the embodiments of the present invention, and not to teach any limit for the scope of the disclosure.

In today's era, in order to improve personal emotions and conduct effective emotional management, people need to manually record, analyze emotion states, and periodically review emotion records, and so on. However, people are usually not able to accurately identify what emotion they are in, intensity of the emotion, and the causes and content that cause it, therefore they are not able to accurately record their own emotion states for analysis and management. For example, when people are in strong emotions, such as in an angry state, in a sad state, etc., they are usually unable to record their true emotions in time. For example, when talking to others, people are usually not able to record the content of the occurred event and the emotion state and changes during the event in time; and after finishing the conversation, they may be not able to accurately remember the emotion state of each segment in the previous event, therefore they cannot accurately summarize his/her overall emotion state for this event.

In order to help people accurately and efficiently conduct emotion management, an embodiment of the disclosure proposes a method and system for providing emotion management assistance, which can help people record, analyze, and manage emotions, especially for conversation or communication between a user and one or more conversation objects. Herein, the conversation object refers to the other object during the user's conversation, which may be another person, such as a lover, child, colleague, parents, etc., or a pet, such as a puppy, kitten, etc., or a virtual character, such as chat bots and any other intelligent computer capable of talking to people, and so on. An embodiment of the disclosure can automatically detect and record the emotion state, conversation content, and the like during a conversation between a user and another person. For a certain conversation between the user and the conversation object, an embodiment of the disclosure may generate an emotion record corresponding to the conversation for the user or a third party, such as a psychologist, to conduct emotion management of the user. Herein, the emotion record for a conversation at least includes at least a portion of content of the conversation, the emotion state of at least one speech segment of the user during the conversation, identity of the conversation object, etc., where the content of the conversation may be presented in the emotion record in a form of text or speech, herein, taking the conversation content in the form of text as an example to set forth for ease of description. A speech segment may be, for example, one or more segments obtained by performing speech segmentation on a speech conversation, which may correspond to a syllable, a word, a phrase, a single sentence, or two or more sentences, and so on. Herein, emotion state includes at least one emotion type and its level.

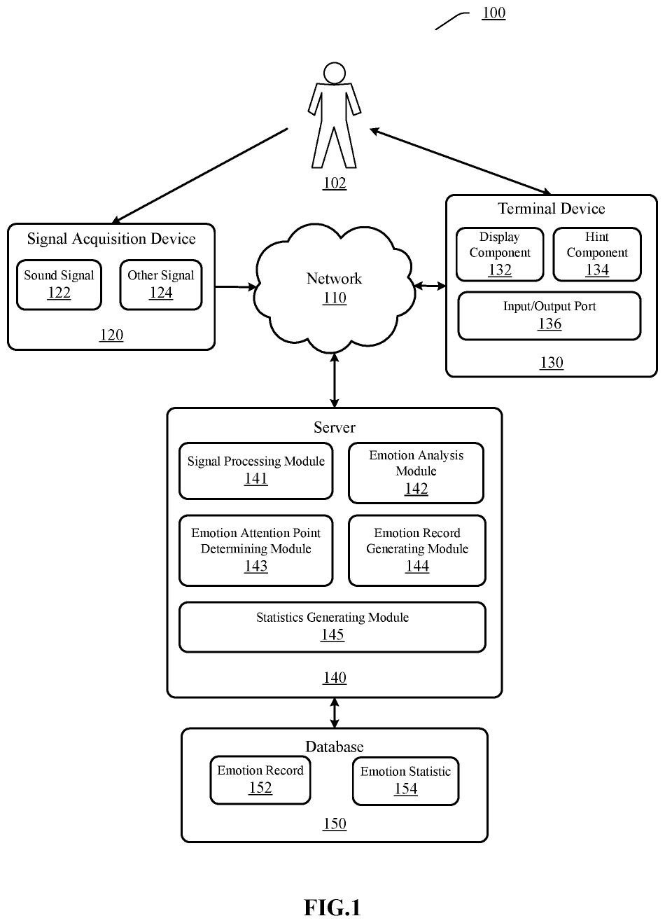

FIG. 1 illustrates architecture of an exemplary emotion management assistance system 100 according to an embodiment. In FIG. 1, a signal acquisition device 120, a terminal device 130, and a server 140 are interconnected through the network 110. The signal acquisition device 120 may include various acquisition devices capable of acquiring a sound signal 122 and other signals 124 such as a user physiological signal and an environmental signal from the user 102, including but not limited to, mobile phone, smart watch, bracelet, tablet, smart robot, Bluetooth headset, clock, thermometer, hygrometer, positioning device that can communicate with the network wirelessly or wiredly, etc. In one example, the acquired sound signal 122 and other signals 124 may be transferred to the server 140 via the network 110 in a wireless or wired manner.

In some embodiments, the server 140 may include a signal processing module 141, an emotion analysis module 142, an emotion attention point determining module 143, an emotion record generating module 144, a statistics generating module 145, and the like.

In one example, the signal processing module 141 may process the received sound signal 122 and/or other signals 124, and convey the processed information to the emotion analysis module 142, and/or the emotion attention point determining module 143, and/or the emotion record generating module 144.

In one example, the emotion analysis module 142 may analyze emotion state of the user according to the received various information, and provide the obtained emotion state to the emotion attention point determining module 143 and the emotion record generating module 144.

In some embodiments, the emotion attention point determining module 143 may determine or predict an emotion attention point at least according to the current emotion state of the user obtained from the emotion analysis module 142 and/or the change between the current emotion state of the user and at least one previous emotion state, and possible information from the signal processing module 141. Herein, an emotion attention point may represent a point in time when the user has or is about to have a transnormal emotion state or emotion state change. In some examples, a determined or predicted emotion attention point may be included and/or indicated in a generated emotion record, so that the user may pay attention to it when viewing the emotion record. In other examples, at the predicted emotion attention point, the server 140 may send an instruction to the terminal device 130 through the network 110 to instruct a hint component 134 in the terminal device 130 to give a hint to the user 102, for example, to remind the user to control current emotion, change current topic or end current conversation, and so on. In some embodiments, the hint may be embodied in various forms, including but not limited to a form of vibration, sound effect, light effect, voice, text, etc.

In some embodiments, the emotion record generating module 144 may generate an emotion record corresponding to the user's conversation according to the obtained various information. For example, the emotion record may include, but is not limited to, time, place, at least a portion of content of the conversation, emotion state, emotion state change, identity of the object involved in the conversation, associated event, and emotion suggestion, etc. In some embodiments, the one or more generated emotion records 152 may be provided to and stored in a database 150. In some embodiments, a plurality of emotion records generated in a predetermined period may be provided to the statistics generating module 145. The statistical generating module 145 may generate an emotional statistics according to the obtained plurality of emotion records, for the user to view the emotion state change in a predetermined period and/or a comparison of the user's emotion state with a reference emotion state. The generated emotion statistics 154 may be stored in the database 150. It is to be understood that although the database 150 is shown as being separated from the server 140 in FIG. 1, the database 150 may also be incorporated into the server 140.

The emotion record 152 and/or the emotion statistics 154 stored in the database 150 may be provided to the terminal device 130 through the server. The terminal device 130 may receive the emotion record 152 and/or the emotion statistics 154 through the input/output port 136 and display the received emotion record 152 and/or the emotion statistics 154 to the user through the display component 132. In some embodiments, the input/output port 136 may also receive input from the user, for example, the user's feedback on the emotion record 152 and/or emotion statistics 154, including but not limited to performing editing operations, such as changing, adding, deleting, and highlighting, etc., to the emotion record and/or emotion statistics. In these embodiments, the terminal device 130 may deliver the received feedback to the server 140 through the network 110. The server 140 may use the feedback to update the emotion record and/or emotion statistics generating process, and provide the regenerated emotion record and/or emotion statistics to the database 150 for storing and/or updating the current emotion record and/or emotion statistics.

In addition, although the signal acquisition device 120 and the terminal device 130 are shown as separate devices in FIG. 1, the signal acquisition device 120 may also be integrated into the terminal device 130. For example, the terminal device 130 may be a mobile phone, a computer, a tablet computer, smart robot, etc., and the signal acquisition device 120 may be a component in the above devices. By way of example, and not limitation, the signal acquisition device 120 may be a microphone, a GPS component, a clock component, etc. in the above devices. Depending on the configuration of the system architecture, the server 140 may be a local server in some examples while a cloud server in other examples.

It should be understood that all of the components or modules shown in FIG. 1 are exemplary. The term “exemplary” used in this application means serving as an example, illustration, or description. Any embodiment or design described as “exemplary” in this application should not be construed as preferred or advantageous over other embodiments or designs. Rather, the use of an exemplary term is intended to convey the idea in a specific manner. The term “or” used in this application means an inclusive “or” rather than an exclusive “or”. That is, “X uses A or B” means any natural inclusive permutation unless otherwise specified or clear from the context. That is, if X uses A, X uses B, or X uses both A and B, “X uses A or B” satisfies any of the above examples. In addition, “a” and “an” items used in this application and the appended claims usually mean “one or more”, unless otherwise specified or clear from the context that it is a singular form.

As used in this application, the terms “component,” “module,” “system,” and similar terms mean a computer-related entity, which may be hardware, firmware, a combination of hardware and software, software, or software in execution. For example, a component can be, but is not limited to being, a process running on a processor, a processor, an object, an executable program, a thread of execution, a program, and/or a computer. For ease of illustration, both the application program running on the computing device and the computing device itself can be components. A process and/or thread in execution may have one or more components, and one component may be located on one computer and/or distributed among two or more computers. In addition, these components can be executed from a variety of computer readable media that store a variety of data structures.

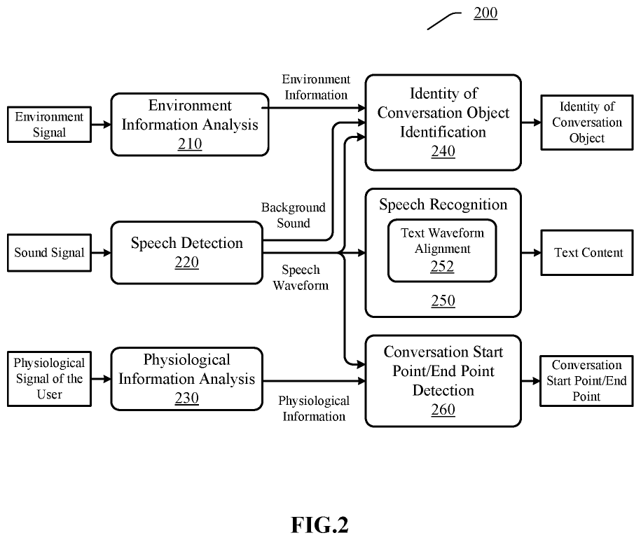

FIG. 2 illustrates an exemplary signal processing process 200 according to an embodiment.

In some embodiments, various signals acquired by the signal acquisition device are processed separately. For example, environment information analysis 210 is performed on an environment signal to obtain environment information. By way of example and not limitation, the environment information may include time information, location information, weather information, temperature information, humidity information, etc. In some examples, speech detection 220 may be performed on the sound signal to detect background sound and speech conversation in the sound signal. For example, speech activity detection (VAD) technique may be used to detect the presence of a speech signal from a sound signal. For example, the presence of a speech signal may be detected by detecting a speech waveform from the sound signal, where various acoustic features may be extracted from the speech waveform. In some examples, the VAD technique may be implemented by various algorithms such as, but not limited to, hidden Markov model, support vector machine, and neural network, which are not described in detail herein. In some examples, the background sound may include, but is not limited to, the sound of wind, car horn, music, children's crying, and the like. In some embodiments, physiological information analysis 230 is performed on the physiological signal of the user to obtain physiological information of the user. In some examples, the physiological information of a user may include, but is not limited to, heart rate, respiratory rate, body temperature, blood pressure, and the like.

At least one of the obtained environment information, background sound, and speech waveform is fed to the block 240 for identifying an identity of the conversation object. The identity of the conversation object may be determined through the processing of block 240. The identified identity of the conversation object may be an identity category to which the conversation object belongs, such as a male or female, or a child, a youth, or an old person, or a pet, etc. The identified identity of the conversation object may also be the name of the conversation object (such as Zhang San), the relationship with the user (such as parents, colleagues), the nickname corresponding to the conversation object (such as dear, baby), or other appellations (such as President Wang, Teacher Zhang), and the like. In some embodiments, the conversation object may also be the user's pet, such as a puppy, a kitten, etc., or may also be a virtual character, such as a chat robot, etc.

In addition, the identity of the conversation object may also be determined according to at least a portion of content of the conversation. For example, if the user says “Hello Teacher Zhang, . . . ”, it may be determined that the identity of the conversation object is “Teacher Zhang”. In some examples, the identity of a conversation object may be determined by using any of the environment information, background sound, acoustic features extracted through speech waveforms, or conversation content, or any combination thereof. Although the identity of the conversation object may be identified by using any of the above items, it may not be accurate enough in some cases, thus the identity of the conversation object may be more accurately identified by using any combination of the above information. For example, if the environment information indicates “10 p.m. on Saturday, home”, and the acoustic feature extracted from the speech waveform indicates “young women”, the identity of the conversation object may be “wife”, “elder sister”, “younger sister” etc. However, if the conversation object says “Elder brother, could you do me a favor?” to the user during the conversation, the identity of the conversation object may be further determined as the “younger sister” of the user according to the content in the conversation.

The obtained speech waveform is provided to block 250 for speech recognition to obtain corresponding text content. The speech recognition process here may employ any known suitable speech recognition technique, and these speech recognition techniques are not described in detail here. In some examples, the speech recognition process 250 may include text waveform alignment processing 252 so that the recognized text content has a time label or time stamp.

The obtained physiological information of the user and the speech waveform of the speech conversation are provided to block 260 to perform conversation start point/end point detection, thereby determining the start point/end point of the speech conversation. In some examples, the start point/end point of a conversation may be determined according to the speech waveform of the speech conversation. For example, a conversation may be considered to start when the presence of a speech waveform is detected, and the conversation may be considered to end when no speech waveform is detected after a predetermined period has elapsed during the conversation. In some examples, the start point/end point of a conversation may be determined according to the physiological information of the user. For example, a conversation may be considered to start when changes in the physiological information of the user, such as raised blood pressure, faster heart rate, etc. are detected, and the conversation may be considered to end when the user's blood pressure and heart rate are detected to become normal during the conversation.

It is to be understood that all the blocks and their input information and output information shown in FIG. 2 are exemplary, and the blocks may be added or merged, and the input information and output information of the blocks may be increased or decreased, according to specific settings. For example, although not shown in FIG. 2, there may be a scene detection operation for determining a scene in which a conversation occurs according to at least one of background sound, at least a portion of content of a speech conversation, and environment information. In addition, the identity of the conversation object may also be identified further according to the determined scenario. For example, when the determined scene is “10 a.m. on Monday, office”, the identity of the conversation object may be identified as a colleague, and when the determined scene is “10 p.m. on Saturday, home”, the identity of the conversation object may be identified as spouse, etc. In addition, optionally, although not shown, background sound and environment information may also be fed to block 260 for detecting the start point/end point of a conversation. For example, if the background sound includes a door opening sound and a door closing sound, the start point of the conversation may be determined according to the door opening sound in the background sound, and/or the end point of the conversation may be determined according to the door closing sound. As another example, if the speech conversation is a voice call made through a communication device such as a mobile phone, the instant at which the call is initiated may be considered as the start point of the conversation, and the instant at which the call ends may be considered as the end point of the conversation. In some examples, when the location information in the environment information indicates that the user is currently in a conference room, the conversation may be considered to start, and when the location information indicates that the user is leaving the conference room, the conversation may be considered to end. Although in the above example, environment information, background sound, speech waveform, and physiological information are separately used to determine the start point/end point of a conversation, any combination of these information may be used to determine the start point/end point of the conversation. In addition, it is to be understood that an embodiment of the present disclosure may establish a machine learning-based conversation start point/end point detection model, which may use one or more of the above-mentioned environment information, background sound, speech waveform, physiological information etc. as features, and be trained to determine the start point/end point of a conversation. The model is not limited to be established by using any specific machine learning technique.

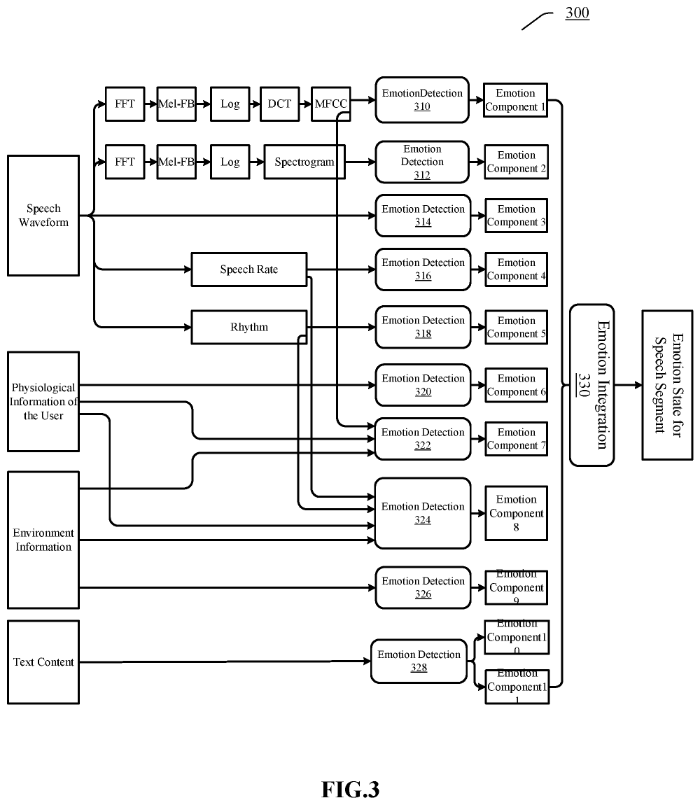

FIG. 3 illustrates an exemplary emotion analysis process 300 according to an embodiment. In this embodiment, the emotion state of a speech segment of the user generated by the exemplary emotion analysis process is for a speech segment of the user during the speech conversation between the user and the conversation object.

Various approaches may be adopted to perform speech feature extraction on the speech waveform and perform emotion detection for the user according to the extracted speech features. For example, as shown in FIG. 3, in one approach, MFCC features may be extracted from a speech waveform through a series of processing including fast Fourier transform (FFT), Mel-Filter Banks (Mel-FB), log (Log), discrete cosine transform (DCT), Mel frequency cepstrum coefficient (MFCC) transform etc., and the extracted MFCC features is provided to block 310 to perform emotion detection for the user and generate emotion component 1 based on these features. In some examples, the emotion component may be in the form of multi-dimensional vector, such as [emotion type 1 (level or score), emotion type 2 (level or score), emotion type 3 (level or score), . . . emotion type n (level or score)], where n is greater than or equal to 2 and can be a preset value or a default value, such as 4 emotion types (for example, joy, anger, sorrow, happiness), 6 emotion types (for example, happiness, sadness, anger, disgust, fear, surprise), 8 emotion types (for example, anger, disgust, fear, sadness, anticipation, happiness, surprise, trust) etc. In the following, embodiments of the disclosure will be described by taking six emotion types, that is, 6-dimensional vectors as an example, but in other embodiments, emotion components of other dimensional vectors are also possible. For example, an emotion component may be [happiness (20), sadness (15), anger (43), disgust (10), fear (23), surprise (11)]. In other examples, emotion component may also be in the form of a single-dimensional vector, such as [emotion type (level or score)]. The single-dimensional vector may be obtained by calculating a multi-dimensional vector of emotion. For example, the emotion type with the highest score or level in the multi-dimensional vector and its score or level are represented as the emotion component in the form of a single-dimensional vector. For example, a multi-dimensional vector of an emotion component [happiness (20), sadness (15), anger (43), disgust (10), fear (23), surprise (11)] may be converted into a single-dimensional vector [anger (43)]. In some examples, a weight may also be assigned to each dimension in the multi-dimensional vector, and a single-dimensional vector including an emotion type and its score or level is calculated based on a weighted sum of the respective dimensions.

In another approach, spectrogram features may be extracted from a speech waveform through a series of processing including FFT, Mel-FB, Log, spectrogram transform etc., and the extracted spectrogram features may be provide to block 312 to perform emotion detection for the user and generate emotion component 2 based on these features.

In yet another approach, the speech waveform may be provided directly to block 314 to perform emotion detection for the user and generate an emotion component 3 based on the speech waveform.

In another approach, speech rate feature may be extracted from a speech waveform, and the extracted speech rate feature may be provided to block 316 to perform emotion detection and generate an emotion component 4 based on the speech rate.

In yet another approach, rhythm feature may be extracted from a speech waveform, and the rhythm feature may be provided to block 318 to perform emotion detection and generate an emotion component 5 based on the rhythm.

Emotion detection may be performed based on various above-mentioned features extracted from a speech waveform through various known emotion detection techniques for speech, and an emotion or an emotion component for the speech waveform may be obtained, these known emotion detection techniques are not described in detail here.

In some embodiments, the obtained physiological information of a user may be provided to block 320. In block 320, emotion of the user is detected based on physiological information of the user and an emotion component 6 is generated. For example, based on the user's blood pressure exceeding a predetermined amount of a normal value, the user's current emotion state [excitement or rage or anger, high level or score 50] may be detected and generated as the emotion component 6.

In some embodiments, emotion detection for a user may be performed and an emotion component 7 may be generated at block 322 based on the physiological information of the user, MFCC feature and environment information extracted from the speech waveform. For example, when it is determined that the user's heartbeat frequency exceeds a normal value, and the user is currently in a playground (i.e., the location information in the environment information), the current emotion of the user may be detected as [happiness (high level)] based on the MFCC feature extracted from the speech waveform. For simplicity, the form of single-dimensional vector is used here to represent the emotion component. It is to be understood that it is also possible to use a form of multi-dimensional vector to represent current emotion of a user in other embodiments.

In some embodiments, emotion detection may be performed and an emotion component 8 may be generated at block 324 based on the speech rate feature, rhythm feature extracted from the speech waveform, physiological information of the user and environment information.

In some embodiments, environment information may be provided to block 326 for emotion detection and generating an emotion component 9. For example, if the environment information indicates that the temperature is 36 degrees, the humidity is 20%, the location is an office, and the time is 4 p.m. on Monday, then the emotion of the user may be detected as [disgust (high or score 50)] based on the above environment information.

In some embodiments, at least a portion of generated content corresponding to a speech conversation may be provided to block 328 to detect the user's emotion based on the at least a portion of the text content, for example, the emotion component 10 detected directly through the text content and the hidden emotion component 11 indirectly obtained. By way of example and not limitation, when the text content of a speech conversation is “I am very angry”, the emotion component of the user may be detected as rage based on the text content. As another example, when the text content of a speech conversation is “Should I be angry?”, the hidden emotion component of the user may be detected as surprise based on the text content.

It is to be understood that the above emotion detection operations 310-328 can all be implemented by a pre-trained model.

Any one or more of the generated emotion component 1 to emotion component 11 may be provided to block 330 to perform emotion integration to output an emotion state for a speech segment of a user, where the emotion state may be in the form of multi-dimensional vector or single-dimensional vector. Herein, the emotion state includes at least one emotion type and its level. For example, the emotion state of a single-dimensional vector may be represented as [emotion type (level or score)], and the emotion state of a multi-dimensional vector may be represented as [emotion type A (level or score), emotion type B (level or score), emotion type C (level or score) . . . ].

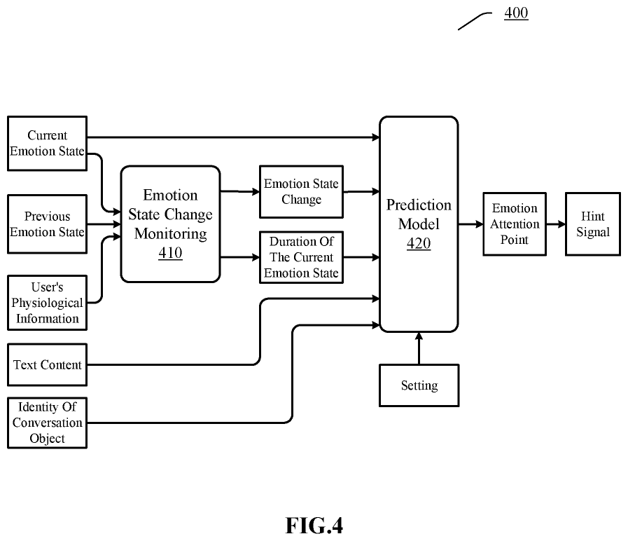

FIG. 4 illustrates an exemplary emotion attention point determining process 400 according to an embodiment.

As shown in FIG. 4, the user's current emotion state, previous emotion state, and the user's physiological information may be provided to block 410 for emotion state change monitoring, where the user's current emotion state represents the emotion state for the current speech segment of the user, and the user's previous emotion state represents one or more emotion states for one or more previous speech segments of the user. If the current emotion state of a user changes compared to the previous emotion state, or the physiological information of a user changes, such as blood pressure rising, heart rate becoming faster, etc., the emotion state change of a user may be monitored, where the emotion state change of a user includes at least one of: emotion type change, level change of the same emotion type. For example, the emotion state change of a user may include at least one of: changing from happiness to sadness, changing from low level of sadness to high level of sadness, or changing from low level of happiness to high level of sadness, etc. If the current emotion state of a user has not changed compared to the previous emotion state, or the physiological information of a user has not changed, it may be concluded that the current emotion state of the user has not changed within a certain period before, and duration of the current emotion state may be determined.

At least one of a current emotion state of a user, emotion state change, a duration of the current emotion state, at least a portion of the text content of a speech conversation, and the identity of a conversation object is input to a prediction model 420. The prediction model 420 may predict an emotion attention point based on the received information and predetermined settings. The predetermined settings may be, for example, at least one setting obtained from a setting storage unit, including but not limited to, non-user-specific default setting, user-specific setting, and the like. In some examples, exemplary settings may include, but is not limited to, at least one of: triggering emotion attention point prediction when the emotion type changes, triggering emotion attention point prediction when the level or score of a certain emotion type exceeds a threshold, triggering emotion attention point prediction in a case of the current emotion state lasted for a predetermined period, triggering emotion attention point prediction when the conversation content involves a sensitive topic, and so on.

For example, an exemplary default setting may include, but is not limited to, at least one of: triggering emotion attention point prediction when the emotion type changes from no rage to rage, triggering emotion attention point prediction when the level of an emotion type “rage” and “sadness” is high or its score exceeds a threshold, triggering emotion attention point prediction in a case of the current emotion state “rage (medium or high)” and “sadness (medium or high)” lasting for a predetermined period, triggering emotion attention point prediction when the conversation content involves a topic of “gambling”, “drugs”, and so on.

In some examples, the user-specific settings may be the same as or different from default settings. For example, if a user is a depression patient, the user-specific settings may include, but is not limited to the following examples: triggering emotion attention point prediction when the level of an emotion type “happiness” is low or its score is below a threshold, triggering emotion attention point prediction when the emotion type changes from no sadness to sadness, triggering emotion attention point prediction when the level of an emotion type “rage” and “sadness” is medium or its score exceeds a threshold, triggering emotion attention point prediction in a case of the current emotion state “sadness (medium or high)”, etc. lasting for a predetermined period, triggering emotion attention point prediction when the conversation content involves a topic of “suicide”, and so on. As another example, if the user is irritable, an user-specific setting may set a threshold for the emotion type “anger” above the corresponding threshold in the default setting, set the duration of the predetermined period of the current emotion state to be lower than the corresponding duration in the default setting, triggering emotion attention point prediction when the conversation content involves an insulting topic, and so on.

In addition, user-specific settings may also include settings for a specific conversation object. For example, when the conversation object is a spouse, an exemplary setting may include, but is not limited to, triggering emotion attention point prediction when the emotion state changes to “disgust (medium)”, triggering emotion attention point prediction when the conversation content involves a topic of “divorce”, and so on. As another example, when the conversation object is a child, an exemplary setting may include, but is not limited to, triggering emotion attention point prediction in a case of the emotion state “happiness (low)” lasting for a predetermined period, triggering emotion attention point prediction when the conversation content involves a word or topic of “idiot”, and so on.

Although the settings are shown in FIG. 4 as being obtained from outside the prediction model 420, the settings may be configured inside the prediction model 420. Optionally, at a predicted emotion attention point or at a predetermined time point before the emotion attention point, a hint signal may be generated to provide the user with a hint related to emotion management, such as vibration, a sound effect, a light effect, a speech hint, a text hint, etc. For example, the hint may be a content of “clam down” in the form of speech or text, soft music, soft lighting, and so on.

During a training phase, the prediction model 420 may be trained based on emotion state change, duration of the current emotion state, text content, identity of the conversation object, predetermined settings, and history data of a user. For example, when there is no history data of a user, the prediction model may predict an emotion attention point based on emotion state change, duration of the current emotion state, text content, identity of the conversation object, predetermined settings, where it is thought that the user may be in a transnormal emotion state at this predicted emotion attention point. However, if there is history data of a user and it is found that in the history data of the user, the user did not have a transnormal emotion state at the predicted emotion attention point or has a transnormal emotion state at another time point, the history data of the user may be used to retrain the prediction model, for example, this another time point is used as an emotion attention point predicted by the retrained prediction model.

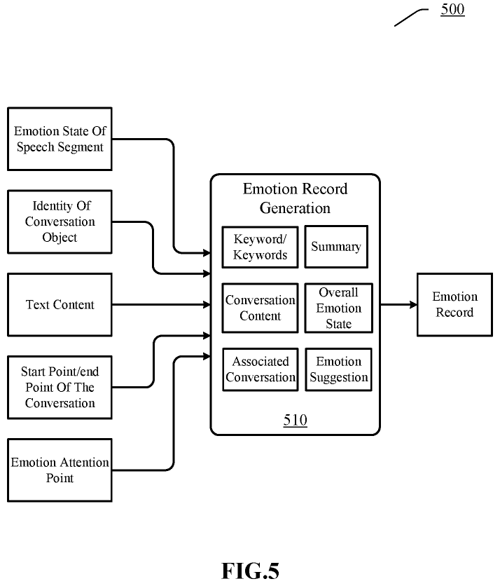

FIG. 5 illustrates an exemplary emotion record generating process 500 according to an embodiment.

The emotion state of at least one speech segment generated by an emotion analysis process, the identity of a conversation object generated by a signal processing process, the text content, the start point/end point of the conversation, and the emotion attention point determined/predicted through an emotion attention point determination process are provided to block 510 to generate an emotion record for a speech conversation. In some embodiments, an emotion record for a speech conversation of a user may include at least a text content of at least one speech segment of the user in the speech conversation and an emotion state of each speech segment in the at least one speech segment. In some embodiments, an emotion record for a speech conversation of a user may include one or more of: keyword/keywords extracted from the speech conversation, a summary of the speech conversation, and the entire conversation content of the speech conversation (including content of the conversation object), the overall emotion state of a user for the speech conversation, other conversations of the user associated with the speech conversation, and an emotion suggestion. The overall emotion state may be calculated based on the emotion state of at least one speech segment of the user in the speech conversation, where the calculation may include any suitable known summation, including but not limited to cumulative summation, weighted summation, etc. An emotion suggestion may be a suggestion for emotion improvement at an emotion attention point.

FIG. 6 illustrates a flowchart of an exemplary method 600 for providing emotion management assistance according to an embodiment.

At 602, sound signals, physiological signals of a user, environment signals, and the like may be acquired. These signals are acquired, for example, through devices such as mobile phones, Bluetooth headsets, bracelets, smart watches, thermometers, hygrometers, smart robots, positioning devices, clocks, etc.

At 604, the sound information, the physiological information of a user, and the environmental information, etc. may be obtained by performing signal processing separately on the acquired sound signals, physiological signals of the user, and environment signals.

At 606, a speech conversation and background sound may be detected from the acquired sound information.

At 608, a start point and/or end point of a speech conversation is determined based on at least one of the speech conversation and/or background sound detected at 606, and optionally the physiological information of the user and environment information obtained at 604. For example, the beginning of a speech conversation may be determined based on detecting the presence of speech in the sound streams, i.e., the user or the conversation object begins to talk. For example, the end of a speech conversation may be determined based on the fact that no speech has continued to be received for a predetermined time after the start of the speech conversation or during the conversation. In some examples, if the background sound includes a door opening sound and a door closing sound, the instant when the door opening sound occurs may be determined as the start point of the conversation, and the instant when the door closing sound occurs may be determined as the end point of the conversation. In other examples, if the physiological information of a user shows that the user's heartbeat frequency suddenly changes from normal to accelerated, the instant when the user's heartbeat frequency starts to accelerate may be considered as the start point of the conversation, and the instant when the heartbeat frequency becomes the normal frequency again may be considered as the end point of the conversation. In some examples, if the location information in the environment information indicates that the user is currently in a conference room, the current instant may be considered as the start point of the conversation, and if the location information indicates that the user is leaving the conference room, the instant of the user leaving the conference room may be considered as the end point of the conversation. Although some examples are listed above to illustrate that the start point and/or end point of a speech conversation may be determined according to the speech, background sound in the sound information, physiological information of a user, and environment information separately, it is preferable to use any combination of the above information to determine the start point/end point of the conversation.

At 610, the identity of a conversation object is identified based on the speech conversation and/or background sound detected at 606, and optionally the environment information obtained at 604, and the like. Specifically, the identity of the conversation object is identified based on the speech of the conversation object in the detected speech conversation. In some embodiments, the identity of an object labeled with an acoustic feature may be stored in the database in advance, or may be stored in the database in the form of an entry of the [object ID, acoustic feature] pair, such as [child, acoustic feature A], [user's spouse, acoustic feature B], [pet dog, acoustic feature C], [chat bot, acoustic feature D], etc. The acoustic feature here may be a multi-dimensional acoustic feature vector or an object-specific acoustic model. When it is detected that the user is having a conversation with a conversation object, the speech feature may be extracted from the speech of the conversation object, and, for example, a recognition model is used to look up in a database whether there is an acoustic feature corresponding to the extracted speech feature. If there is, the object ID labeled or paired with the acoustic feature is identified as the identity of the conversation object, such as the user's spouse, child, etc. If there is not, the identity of the conversation object may be identified such as an unknown or stranger. Optionally, the identity of the conversation object may be identified as a male or female, or as a child, a youth, or an elderly through a classifier according to a preset setting, or may be further identified as a little girl, a little boy, a female youth, a male youth, or a female elderly, a male elderly, etc. In addition, if there are multiple entries in the database for a same object, for example, there may be multiple entries for the user's spouse, [wife, acoustic feature B], [name, acoustic feature B], [dear, acoustic feature B], one or more of these entries may be arbitrarily selected to identify the identity of the conversation object.

Optionally, the identity of the conversation object may be identified according to the environment information and/or the background sound detected from the sound information. For example, if the background sound indicates TV sound, the environment information indicates the time is “11:00 p.m.”, and the location is “home”, then the conversation object may be identified as the user's spouse; if the environment information indicates that the time is “10:00 a.m. on Monday” and the location is “company”, the conversation object may be identified as a colleague. As another example, if the environment information indicates the time is “12 noon” and the location is “outdoor”, and the background sound indicates the sound of a station announcement on public transportation, then the conversation object may be identified as a stranger. Although some examples are listed above to illustrate that the identity of a conversation object may be identified based on the speech of the conversation object, background sound, and environment information separately, it is preferable to identify the identity of the conversation object based on any combination of the above information.

Further, in some examples, the identity of a conversation object may be identified based on at least a portion of the content of the speech conversation. For example, if the content said by the user is “Baby, let's play a game”, the conversation object may be identified as a child based on “baby” included in the content; if the content said by the user is “Dear, good morning”, the conversation object may be identified or determined as a spouse based on “dear” included in the content; if the content said by the user is “Xiaobing, how is the weather today?”, the conversation object may be identified as a virtual character “Xiaobing” based on the “Xiaobing” included in the content, “Xiaobing” here represents Microsoft's artificial intelligence robot. In some examples, the identity of a conversation object may be identified based on at least one of speech of the conversation object, background sound, environment information, at least one portion of the content of the conversation, or any combination thereof.

It is to be understood that the processing of identifying the identity of a conversation object at 610 may be implemented by establishing a machine learning-based conversation object identity identification model. This model may use one or more of speech conversation, background sound, environment information, at least one portion of the content of the speech conversation described above as features, and may be trained to output the identity of the conversation object. The model is not limited to be established by using any specific machine learning technique.

At 612, the text content of a speech conversation may be identified from the speech conversation detected at 606. Any known suitable speech recognition technique can be used to recognize text content from a speech conversation, these speech recognition techniques are not described in detail herein, to avoid obscuring the concept of the disclosure.

At 614, the emotion state of a user may be determined according to at least one of the sound information, the physiological information of a user and environment information obtained at 604, and the text content of the speech recognized at 612. Specifically, an emotion state is determined for at least one speech segment of a user during a conversation. Emotion state of each speech segment in the at least one speech segment of a user includes an emotion type of a user for the speech segment and/or level of the emotion type, where the emotion types may be classified into any number of types, such as four types (joy, anger, sorrow, happiness), six types (happiness, sadness, anger, disgust, fear, surprise), etc. and the levels of emotion types may be represented by grades and/or scores, such as grades low, medium, high; grades 1, 2, 3 . . . ; grades A, B, C, D . . . ; scores 0, 10, 20, 30 . . . n, and so on. In the following, it takes the above six emotion types as examples to discuss the emotion state, and the emotion state may be represented as a multi-dimensional vector or a single-dimensional vector. For example, an exemplary emotion state may be a multi-dimensional vector such as [happiness (low), sadness (low), anger (medium), disgust (low), fear (low), surprise (low)), or a single-dimensional vector such as [anger (medium)].

At 616, the emotion state change of a user may be determined according to the emotion state of at least one speech segment of the user determined at 614. For example, the emotion state change of a user is determined according to the current emotion state of the current speech segment and one or more previous emotion states of one or more previous speech segments. This emotion state change may be obtained by calculating, or obtained as the output of a training model. For example, if the emotion state of the current speech segment is [happiness (5), sadness (25), anger (40), disgust (15), fear (20), surprise (10)], the emotion state of a previous speech segment is [happiness (30), sadness (25), anger (20), disgust (10), fear (15), surprise (12)], then the emotion state change may be calculated as [happiness (Δ=−25), sadness (Δ=0), anger (Δ=20), disgust (Δ=5), fear (Δ=5), surprise (Δ=−2)]. When the emotion state change in the form of a multi-dimensional vector is converted into a single-dimensional vector, the single-dimensional emotion state change may be determined by comparing the absolute value of the change value of each dimension, for example, taking the dimension with the highest absolute value in the multi-dimensional vector as the dimension of a single-dimensional vector. For example, since the absolute value of the score of the “happiness” dimension among the above-mentioned multi-dimensional emotion state change is the highest (25), the above multi-dimensional emotion state changes may be converted into a single-dimensional emotion state change [happiness (Δ=−25)]. In some examples, each dimension in the multi-dimensional vector may be assigned a corresponding weight, and the emotion state change may be calculated as a weighted value of each dimension. For example, if the weight of each dimension are {happiness 0.1, sadness 0.2, anger 0.3, disgust 0.2, fear 0.1, surprise 0.1}, the weighted value of emotion state change is calculated as [happiness (Δ=−25*0.1=−2.5), sadness (Δ=0*0.2=0), anger (Δ=20*0.3=6), disgust (Δ=5*0.2=1), fear (Δ=5*0.1=0.5), surprise (Δ=−2*0.1=−0.2)]. In this example, when the emotion state change of multi-dimensional form is converted into a single-dimensional vector, in a similar way of comparing absolute values, it may be concluded that the single-dimensional emotion state change is [anger (Δ=20*0.3=6) ]. In some embodiments, emotion state change may be determined by training a model. For example, for the sake of simplicity, take a single-dimensional vector as an example, during the training phase, one emotion state is used as the current emotion state, one or more emotion states, as the previous emotion states, are used as the input to the training model, and the emotion state changes are used as the output. For example, if the current emotion state is [anger (low)] and a previous emotion state is [disgust (low)], the outputted emotion state change may be considered as [disgust->anger (weak change)]. As another example, if the current emotion state is [anger (high)] and two previous emotion states are [happiness (high)] and [anger (low)], the outputted emotion state change may be considered as [happiness->anger (strong change)]. The above examples are for ease of understanding of the disclosure, which are illustrative and not limiting.

At 618, according to the emotion state change determined at 616 and optionally the emotion state of at least one speech segment determined at 614, an emotion attention point is predicted/determined through a prediction model. Although not shown in FIG. 6, an emotion attention point may also be determined by a prediction model according to at least one of: current emotion state of the current speech segment, text content of the speech conversation, duration of the current emotion state, topic in the speech conversation, identity of the conversation object, and history emotion records of a user.

Optionally, at 620, a hint may be provided to a user at the predicted emotion attention point, for example, through a hint component, to remind the user to control emotion. For example, the hint may be a vibration, a sound effect, a speech, a text, a light effect generated by a bracelet, a smart watch, a mobile phone, or the like, or controlling other devices to generate a sound effect or a light effect and the like through a hint component. For example, a sound effect may include a ring tone, music, a natural sound such as rain, waves, etc.; a light effect may include a flash, a screen light of different colors, and the like. In some examples, controlling other devices to generate a sound effect and a light effect through a hint component may include: making, for example, speakers emitting music, lights in a house emitting lights of different frequencies or colors, such as flashes, candle-like lights, sunlight-like lights, cold lights, warm lights and the like, according to different instructions through a mobile phone, smart robot, etc.

At 622, an emotion record may be generated according to one or more of: the start point and/or end point of a speech conversation determined at 608, the identity of a conversation object identified at 610, the text content identified at 612, the emotion state of at least one speech segment determined at 614, and optionally emotion attention point predicted/determined at 618. In some examples, an predicted or determined emotion attention point may be indicated in an emotion record. Optionally, according to the obtained environment information, the physiological information of a user, and text content of the speech conversation, and so on, the emotion record may further include at least one of: keyword/keywords extracted from the speech conversation; content summary of the speech conversation; occurrence time of the speech conversation; occurrence location of the speech conversation; overall emotion state of the user in the speech conversation; indication for another conversation of the user associated with the speech conversation (i.e. an associated conversation of the user); and an emotion suggestion. Herein, the overall emotion state of a user in the speech conversation may be a combination or a weighted combination of the emotion states of at least one speech segment of the user. In some embodiments, an emotion suggestion may be generated by retrieving corresponding cases or events from a database by a pre-trained deep learning-based suggestion model. In some embodiments, each case or event in the database may be labeled with keyword/keywords and emotion labels, for example in the form of a label [keyword/keywords, emotion vector]. At least according to the keyword/keywords and/or summary, emotion states included in the current emotion record, a suggesting model may retrieve cases or events with corresponding keyword/keywords and/or summary, emotion states in the database, and include the retrieved cases or events as emotion suggestions in the emotion record. During training, the suggesting model may be trained in ways such as keyword/keywords matching and emotion state improvement.

At 624, a statistical table may be generated based on multiple emotion records corresponding to multiple speech conversations generated at 622. In some embodiments, each emotion record of a plurality of emotion records includes overall emotion state of a user in a speech conversation corresponding to the emotion record. In some examples, the statistical table may include at least one of: a staged emotion state statistics in a predetermined period, a staged emotion change trend in a plurality of predetermined periods, a staged change trend of each emotion in a plurality of predetermined periods, staged emotion statistics for identity of a certain or a same conversation object in a predetermined period, a staged emotion change trend for identity of a certain or a same conversation object in a plurality of predetermined periods, and so on. For example, the statistical table may include: staged emotion state statistics in August 2018, a staged emotion change trend from August 2018 to October 2018, a staged change trend of the emotion “anger” from August 2018 to October 2018, staged emotion statistics for a child in August 2018, a staged emotion change trend for a child from August 2018 to October 2018, and so on.

In some examples, a statistical table may be generated according to a staged emotion state of a user in each of a plurality of predetermined periods. For example, the staged emotion state in each predetermined period may be the sum of at least one overall emotion state of at least one speech conversation of the user in the predetermined period. In some examples, a statistics table may include statistics of staged emotion changes of a user in a predetermined period. In other examples, the statistical table may include statistics of emotion changes of each emotion type of a user in a predetermined period. In still other examples, the statistical table may include statistics of overall emotion states of a user for a plurality of different identities of conversation objects. In yet other examples, the statistical table may include statistics of overall emotion states of a user for an identity of a specific conversation object.

At 626, the generated emotion record and/or statistical table is displayed to the user or a third party, for example, the third party may be the user's spouse, psychologist or other person authorized by the user. The emotion record and/or statistical table may be displayed to a user or a third party through a display component in a terminal device of the user or the third party.

Optionally, at 628, feedback on the emotion record and/or statistical table may be received from the user or the third party. For example, the user may edit any item in the emotion record, such as adding, modifying, deleting, etc. For example, if the identity of a conversation object included in the emotion record is shown as “colleague”, but the actual conversation object is “wife”, the user can modify the identity of the conversation object in the emotion record. The modified emotion record may be provided to the user as an updated emotion record and/or stored in a database as history data to retrain the model. For example, the updated emotion record is used to update the object identities labeled with acoustic features stored in the database to retrain the recognition model to identify the identity of the conversation object, and the updated emotion record is provided to the prediction model to retrain the prediction model for predicting an emotion attention point, etc. Other items of the emotion record may be modified by the user or the third party, so that the updated emotion record may also be used in other parts of the emotion management assistance process.

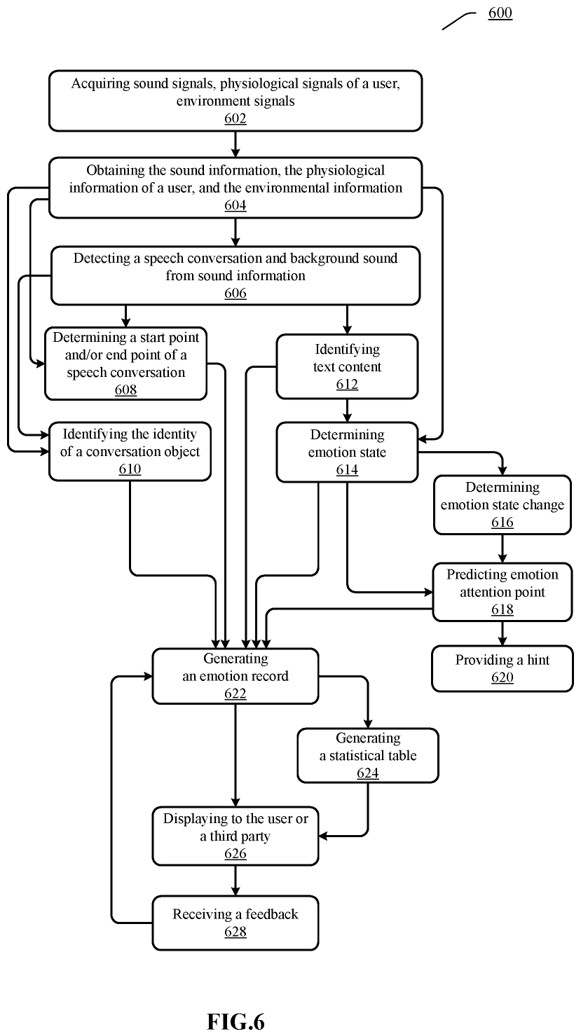

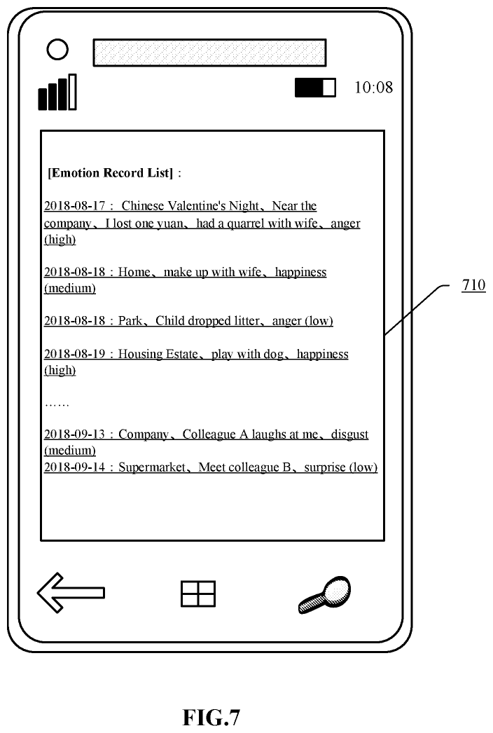

FIG. 7 illustrates an exemplary interface for displaying an emotion record list 710 according to an embodiment. The interface is displayed on an exemplary display component. In this embodiment, each emotion record index in the emotion record list 710 may indicate an emotion record generated based on the exemplary emotion record generating process shown in FIG. 5.

As shown in FIG. 7, the emotion record list 710 includes a plurality of emotion record indexes, where each emotion record index corresponds to an emotion record of a conversation of a user. In some embodiments, the emotion record index may be displayed with any one or more of a plurality of labels such as time, location, conversation object, overall emotion state, event, etc. and linked to the corresponding emotion record, such as the link form shown underlined in FIG. 7. In some embodiments, the emotion record index may also be displayed with labels such as keyword/keywords and/or summary in the emotion record, overall emotion state, etc.

If the index of any item in the emotion record list in FIG. 7 is clicked, it may be linked to the emotion record corresponding to the index. For example, if the first index in FIG. 7 is clicked, it may be linked to the emotion record shown in FIG. 8.

FIG. 8 illustrates an exemplary interface for displaying an emotion record 810 according to an embodiment. The interface is displayed on an exemplary display component.

As shown in FIG. 8, the exemplary emotion record 810 includes keyword/keywords, summary, overall emotion state, at least a portion of conversation content, associated conversation, and suggestion (i.e., emotion suggestion). In this embodiment, keyword/keywords and summary may be generated from the current conversation content according to known keyword/keywords generating techniques and summary generating techniques. In FIG. 8, the emotion state of a user is indicated for the content (e.g., each sentence) of each speech segment of at least one speech segment of the user during the conversation, for example, the emotion state of a user is indicated as [surprise (low)] for the content of a speech segment “What happened?”, the emotion state of a user is indicated as [surprise (medium)] for the content of a speech segment “Isn't it just one Yuan?”, the emotion state of a user is indicated as [anger (medium)] for the content of a speech segment “Why are you so angry?”. Although only the emotion state of a user for a speech segment of the user is shown in FIG. 8, the emotion state of the user may also be indicated for a speech segment of a conversation object in the conversation, for example, the emotion state of a user for a speech segment of a conversation object may be determined according to the speech content of the conversation object, the physiological information of the user, etc., which is not shown in the figure.

In some embodiments, conversation content included in an emotion record may be displayed in the form of text generated through speech recognition, or directly displayed in the form of speech, or may be any combination of the two forms. For example, as shown in FIG. 8, a combination of text form and speech form is used to present the conversation content. In this embodiment, the content 814 of the speech segment corresponding to an emotion attention point, “Why are you so angry?”, is presented in the form of speech, so that the user can more intuitively review the emotion state of the speech segment here. In other examples, the content of all the speech segments of a user and a conversation object may be presented in the form of text in an emotion record, or the content of all the speech segments of a user and a conversation object may be presented in the form of speech in an emotion record, or the content of all the speech segments of a user is presented in the form of speech and the content of all the speech segments of a conversation object is presented in the form of text in an emotion record, or only the content of the speech segments of a user corresponding to an emotion attention point is presented in the form of speech or text in an emotion record, and so on.

In addition, in some embodiments, the emotion state of a user for at least one speech segment may also be represented by color and shade indicated on the text content of the speech segment, where a corresponding color and shade may be preset for each emotion type and level. For example, the content “Why are you so angry” may be marked in red font to indicate that the emotion state of the user for the content is [anger (medium)]; the content “OK, divorce” may be marked in dark red font to indicate that the emotion state of the user for the content is [anger (high)]. In other embodiments, the emotion state of a user for at least one speech segment may be represented by a color bar corresponding to the speech segment, for example, represented by a color vertical bar on one side or both sides of the conversation content shown in FIG. 8, where a corresponding color and shade may be preset for each emotion type and level.

An overall emotion state for the conversation may be generated based on the emotion state of at least one speech segment. For example, assume that there is at least one speech segment in a conversation, and thereby there is at least one emotion state in the conversation. In the case where the emotion state is a single-dimensional vector, one or more emotion states with the highest level or the highest score among the at least one emotion state are considered as the overall emotion state of the conversation. For example, when there are 5 emotion states such as {[disgust (low)], [disgust (medium)], [anger (low)], [sadness (low)], [anger (high)]} for a conversation, the overall emotion state of the conversation may be considered as [anger (high)]. In another example, when there are 5 emotion states {[disgust (low)], [disgust (high)], [anger (low)], [sadness (low)], [anger (high)]} for a conversation, the overall emotion state of the conversation may be considered as {[disgust (high)], [anger (high)]}. Alternatively, in the case where the emotion state is a multi-dimensional vector, the multi-dimensional vectors of multiple emotion states are summed/weighted summed or averaged to obtain an overall vector, and the emotion state represented by the overall vector is considered as an overall emotion state for the conversation. For example, when there are 5 emotion states for a conversation such as [happiness (10), sadness (15), anger (30), surprise (15), fear (5), disgust (25)], [happiness (5), sadness (10), anger (25), surprise (10), fear (15), disgust (20)], [happiness (20), sadness (5), anger (40), surprise (10), fear (10)), disgust (30)], [happiness (10), sadness (20), anger (35), surprise (15), fear (5), disgust (35)], [happiness (15), sadness (10), anger (45), surprise (5), fear (10), disgust (30)], an overall multi-dimensional vectors may be calculated as [happiness (60), sadness (60), anger (175), surprise (55), fear (45), disgust (140)] by summing up the multi-dimensional vectors. An overall multi-dimensional vector may be converted into a single-dimensional vector [anger (175)] by using a multi-dimensional vector to single-dimensional vector conversion approach, such as selecting one dimension with the highest score in the multiple dimensions as the dimension in a single-dimensional vector, therefor it is considered as an overall emotion state for the conversation.

In addition, based on the emotion attention point determining process of FIG. 4 and the emotion attention point prediction at block 618 in FIG. 6, an emotion attention point 812 may be indicated in the emotion record shown in FIG. 8, and the emotion attention point 812 may be indicated in a way distinguished from other emotion states. For example, in this embodiment, an emotion attention point 812 is indicated in a form of “** [anger (medium)] **”, which indicates that an emotion attention point is predicted when the user said “Why are you so angry?”, that is, the user's emotion may in turn becomes transnormal. In other embodiments, an emotion attention point may also be indicated in an emotion record in other ways, for example, an emotion attention point may be indicated with a color different from other emotion states, or the emotion attention point may be indicated with a form of highlighting, bold, and the like. Although an emotion attention point is shown in FIG. 8, it is to be understood that there may be no emotion attention point, more than one emotion attention point, etc. during the conversation. The example shown in FIG. 8 may represent an emotion record performed after the conversation has completed. Emotion attention points are indicated in the emotion record for the user to perform emotion analysis after the conversation has completed, in order to control emotion in the next similar conversation. For example, referring to FIG. 8, emotion state of the user after the emotion attention point becomes [anger (high)] and the user utters the words “OK, divorce” which are adverse to the friendly relationship with the conversation object. In other examples, during the ongoing conversation, a hint, such as a speech hint “Calm down”, may be provided to the user at the predicted emotion attention point [anger (medium)], that is, at the location corresponding to the speech segment of the user “Why are you so angry?”, to prevent the user's emotion state from becoming [anger (high)]. For example, in these examples, when the user receives the hint “Calm down” at the emotion attention point, the subsequent emotion state may not become [anger (high)], but instead become [anger (low)] based on the hint and may say something different, such as content “Don't be so angry”.

In the example shown in FIG. 8, associated conversations of the user may be retrieved based on one or more of keyword/keywords, summary, overall emotion state, etc. in the current emotion record, for example, from storage unit storing personal data of a user. The retrieved associated conversations may be included in the emotion record in the form of a summary or an emotion list index, and may be linked to specific conversation content or emotion record through the index.

In addition, a suggestion, for example, an emotion suggestion, may also be included in an emotion record. The emotion suggestion may be presented in any suitable way, for example, presented in the form of “<suggested content>-<index of an item linked to a web page or database>” as shown in FIG. 8.

It is to be understood that although one emotion state is generated and displayed for each of the four sentences of the user in FIG. 8, that is, all the generated emotion states are displayed, for example, four emotion states are displayed; however, in other embodiments, one or more of the generated emotion states may be displayed, for example, only the emotion state at the emotion attention point, the emotion state of the last speech segment of the user, the emotion state with specific emotion type (e.g., “anger”), or the emotion state with specific level (e.g., “high”), etc., is displayed.

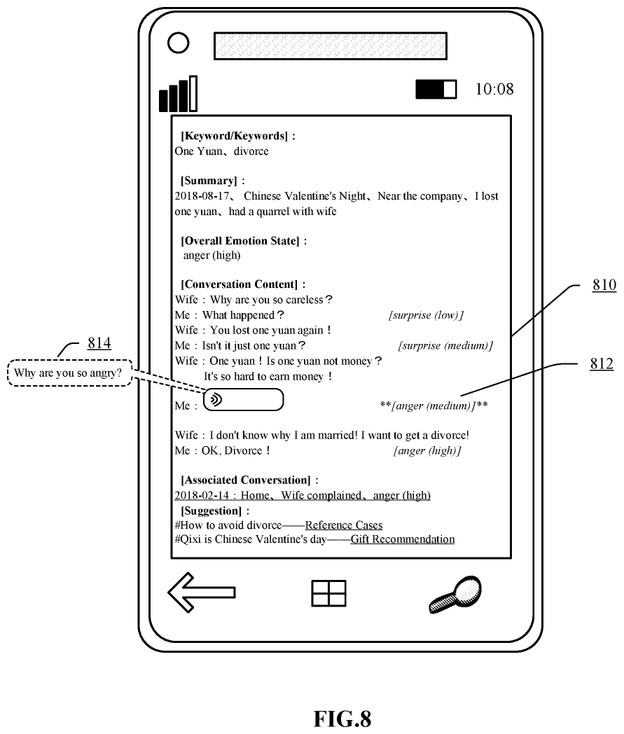

The overall emotion state in the emotion record of FIG. 8 may also be a multi-dimensional vector and be presented in a chart form, as shown in FIG. 9.

FIG. 9 illustrates an exemplary overall emotion state 900 in a form of chart according to an embodiment. In this embodiment, the overall emotion state for a speech conversation of a user may be represented in a multi-dimensional form, such as the shown solid box connecting the emotion points, for example, the solid box connected by the points [happiness (15), sadness (27), anger (46), surprise (25), fear (18), disgust (25)]. It is to be understood that the scores in the appended drawings and the above-mentioned multi-dimensional vectors are all exemplary. In some embodiments, for each of the multiple conversations of the user, a reference overall emotion state may be generated by a reference emotion generating model. The reference emotion generating model may be pre-trained, and takes speech waveform, text content, environment information, etc. similar to the conversation of the user as inputs to output a reference overall emotion state as the emotion management target for the user. As shown in FIG. 9, the dotted box connecting the emotion points may be considered as a reference overall emotion state of the conversation for the user. By comparing the overall emotion state in the chart with the reference overall emotion state, the user may adjust or control his or her own emotion state in subsequent similar conversations to match or approximate the reference overall emotion state.

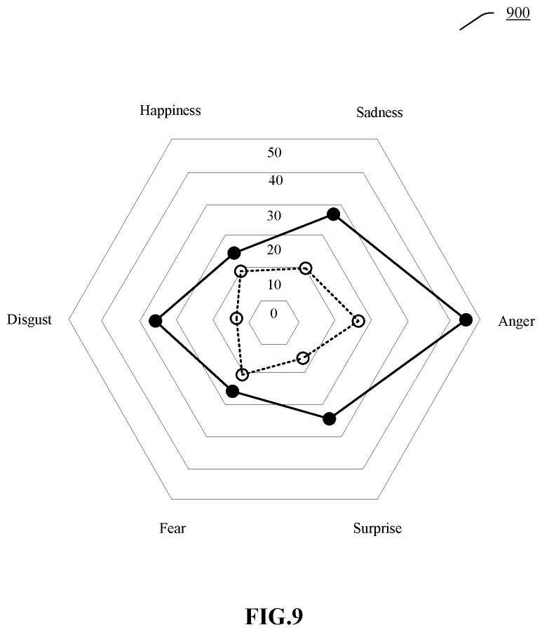

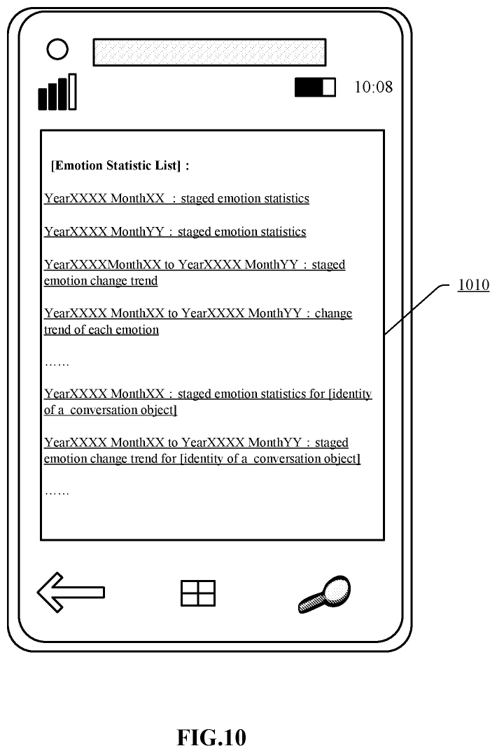

FIG. 10 illustrates an exemplary interface for displaying an emotion statistic list 1010 according to an embodiment. The interface is displayed on an exemplary display component. The emotion statistics list 1010 may include various forms of emotion statistics indexes to link to the corresponding emotion statistics. For example, as shown in FIG. 10, the emotion statistics index included in the emotion statistics list 1010 may be an index for one or more of the following emotion statistics: a staged emotion state statistics in a predetermined period, a staged emotion change trend in a plurality of predetermined periods, a staged change trend of each emotion in a plurality of predetermined periods, staged emotion statistics for identity of a certain or a same conversation object in a predetermined period, a staged emotion change trend for identity of a certain or a same conversation object in a plurality of predetermined periods, and so on. Several types of exemplary emotion statistics are shown below in conjunction with FIGS. 11-14.

FIGS. 11A-11B illustrate exemplary staged emotion states 1100(A) and 1100(B) of a user in different predetermined periods according to an embodiment. For example, FIG. 11A shows a chart for a user in “Year XXXX Month XX: staged emotion statistics” shown in FIG. 10; FIG. 11B shows a chart for a user in “Year XXXX Month YY: staged emotion statistics” shown in FIG. 10. In this embodiment, the staged emotion state may be in the form of a multi-dimensional vector and may be represented by a solid box formed by connecting points, where each point represents the staged score of each dimension (i.e., each emotion type) in the multi-dimensional vector. In this embodiment, a dotted box formed by connecting the points represents a reference staged emotion state, which is similar to FIG. 9. In the charts 1100 (A) and 1100 (B), the staged score of each emotion type represents the sum or average of at least one score of the emotion type in at least one overall emotion state of at least one emotion record in a predetermined period. For example, assume that the user has three emotion records in Year XXXX, Month XX, and each emotion record has an overall emotion state in a multi-dimensional form [happiness (A1), sadness (B1), anger (C1), disgust (D1), fear (E1), surprise (F1)], [happiness (A2), sadness (B2), anger (C2), disgust (D2), fear (E2), surprise (F2)] and [happiness (A3), sadness (B3), anger (C3), disgust (D3), fear (E3), surprise (F3)], where A1-A3, B1-B3, C1-C3, D1-D3, E1-E3, F1-F3 may each represent a numerical value, for the emotion type “anger” in the chart 1100 (A), the overall emotion score is calculated based on C1, C2, and C3, for example, calculating the sum of C1, C2, and C3 or their average.

It is to be understood that all of the emotion types and their scores shown in the above figures are exemplary. In this application, any number of emotion types and their levels may be used to implement the emotion management assistance for a user.

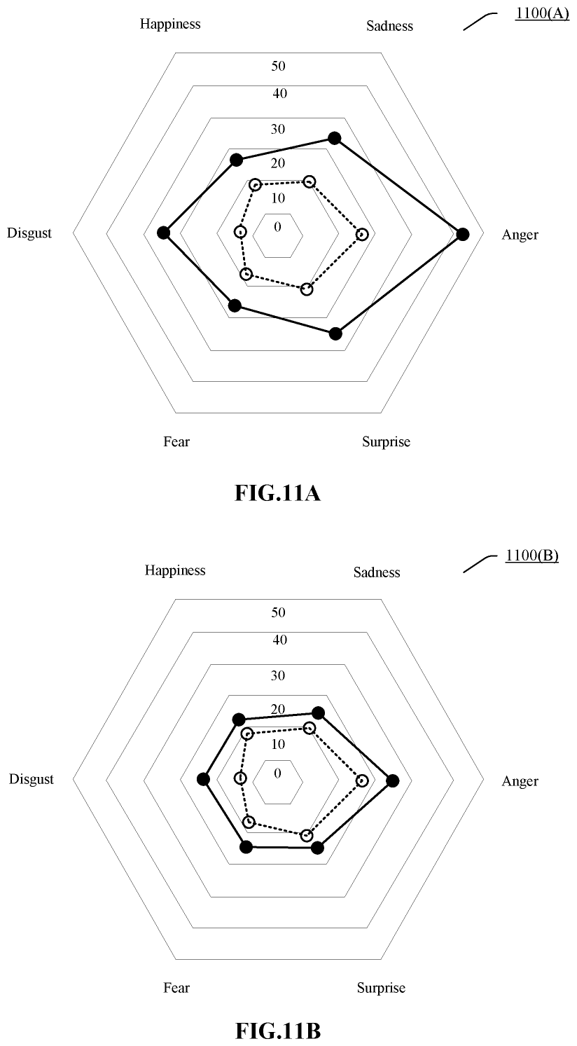

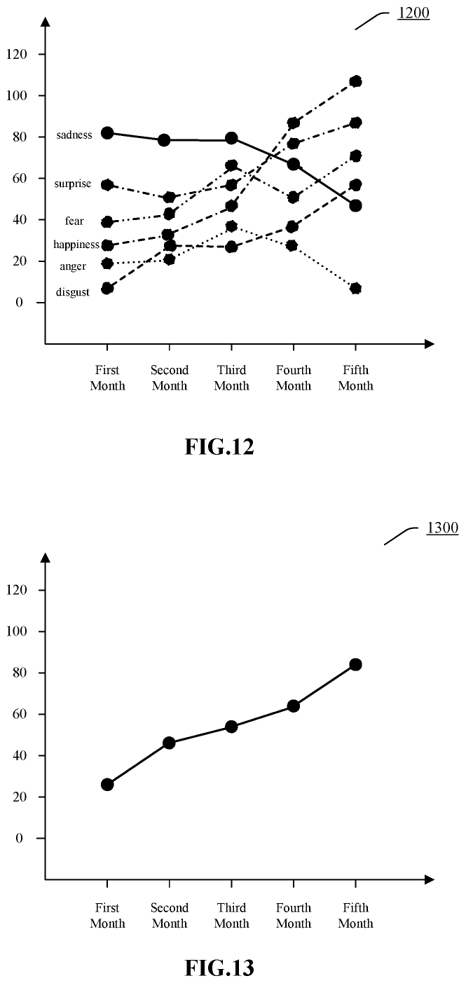

FIG. 12 is an exemplary statistical chart 1200 of staged change of each emotion type in a plurality of predetermined periods according to an embodiment. In the example of FIG. 12, each predetermined period is one month, and the plurality of predetermined periods refer to the 1st-5th months. As described above, there are staged emotion states for each predetermined period. In the example in FIG. 12, the staged emotion state is in a multi-dimensional vector form, where each dimension is each emotion type, i.e., sadness, surprise, fear, happiness, anger, and disgust, for example, the staged emotion state for the first month is [happiness (15), sadness (80), anger (18), surprise (58), fear (40), disgust (9)]. For each emotion type, each point in the figure represents the staged score of that emotion type in each predetermined period (that is, each month). For example, in the first month, based on the emotion of each dimension and its score in the above staged emotion state, it can be known that the score of emotion “sadness” is 80. The examples of FIGS. 11A-11B may be referred to, where each point represents a staged score of each emotion type in a predetermined period. Although the examples of FIGS. 11A-11B show only two periods, the staged score of each emotion type in each period may be obtained in a manner similar to FIGS. 11A-11B. In FIG. 12, the points of each emotion type in each predetermined period are connected to indicate the change trend of the emotion type in multiple predetermined periods.

FIG. 13 is an exemplary statistical chart 1300 of staged emotion state change in a plurality of predetermined periods according to an embodiment. In the example of FIG. 13, each predetermined period is one month, and the plurality of predetermined periods refer to the 1st-5th months, and each point represents a score of the staged emotion state for the period. There is staged emotion state in the form of a multi-dimensional vector for each predetermined period, where each dimension is each emotion type, and the score in the staged emotion state for each predetermined period may be calculated based on the staged score of each emotion type in the predetermined period. In some examples, each emotion type may be assigned a different weight, and the score in the staged emotion state for each predetermined period may be calculated by weighted summing the staged score of each emotion type. For example, each emotion type may be assigned a corresponding weight, such as happiness-0.1, sadness-0.2, anger-0.3, surprise-0.1, fear-0.1, and disgust-0.2. When calculating the score of the staged emotion state of the first month, the staged score of each emotion type in the first month may be multiplied by its weight and then be summed up, and the result may be considered as the score for the staged emotion state of the first month, i.e., the first point shown in FIG. 13.

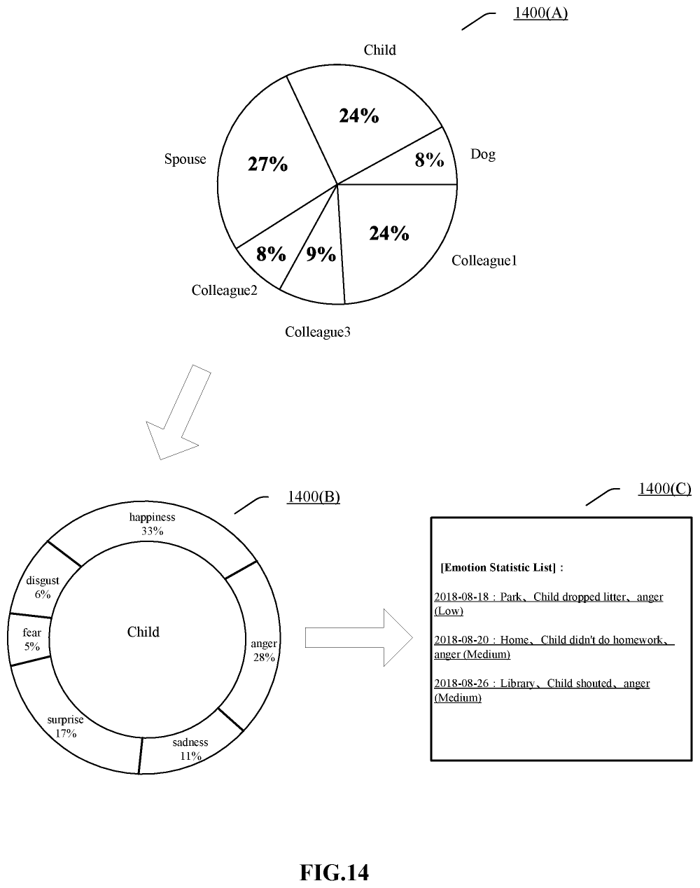

FIG. 14 is an exemplary emotion state statistical chart and an exemplary list of emotion records for different conversation objects according to an embodiment.

Chart 1400 (A) shows the percentage of the time that a user's multiple conversation objects are having a conversation with the user in a predetermined period (e.g., one month).

Chart 1400 (B) shows the percentage of a user with different emotion types relative to the same conversation object (e.g., child). Chart 1400 (B) may be displayed by clicking on the “Child” block in Chart 1400 (A).

Chart 1400 (C) shows a list including at least one emotion record or its index involved in a certain emotion type of a user in a predetermined period relative to a same conversation object. For example, in the example shown in chart 1400 (C), the plurality of emotion records shown are the user's emotion records involving anger emotion for a child in August 2018 or their indexes. Although not shown in FIG. 14, it can be understood that the emotion record index listed in the emotion record list in the chart 1400 (C) may be linked to the corresponding emotion record.

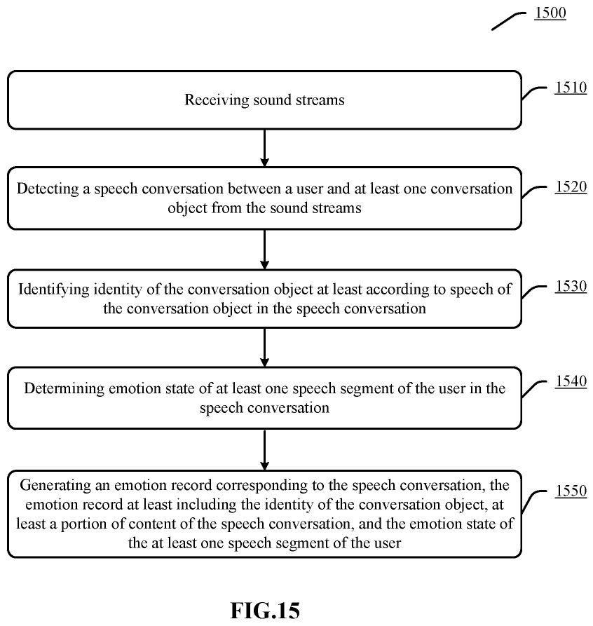

FIG. 15 illustrates a flowchart of an exemplary method 1500 for providing emotion management assistance according to an embodiment.

At 1510, sound streams may be received.

At 1520, a speech conversation between a user and at least one conversation object may be detected from the sound streams.

At 1530, identity of the conversation object may be identified at least according to speech of the conversation object in the speech conversation.

At 1540, emotion state of at least one speech segment of the user in the speech conversation may be determined.

At 1550, an emotion record corresponding to the speech conversation may be generated, the emotion record at least including the identity of the conversation object, at least a portion of content of the speech conversation, and the emotion state of the at least one speech segment of the user.

In an implementation, emotion state of each speech segment in the at least one speech segment of the user includes emotion type of the speech segment and/or level of the emotion type.

In an implementation, detecting the speech conversation comprises: detecting a start point and an end point of the speech conversation at least according to speech of the user and/or speech of the conversation object in the sound streams.

In a further implementation, the start point and the end point of the speech conversation are detected further according to at least one of: physiological information of the user, environment information of the speech conversation, and background sound in the sound streams.

In an implementation, the identity of the conversation object is identified further according to at least one of: environment information of the speech conversation, background sound in the sound streams, and at least a portion of content of the speech conversation.

In an implementation, emotion state of each speech segment in the at least one speech segment of the user is determined according to at least one of: waveform of the speech segment, physiological information of the user corresponding to the speech segment, and environment information corresponding to the speech segment.

In an implementation, the emotion record further includes at least one of: keywords extracted from the speech conversation; content summary of the speech conversation; occurrence time of the speech conversation; occurrence location of the speech conversation; overall emotion state of the user in the speech conversation; indication for another conversation of the user associated with the speech conversation; and emotion suggestion.

In addition, the method further comprises: determining emotion state change of the user at least according to current emotion state of current speech segment of the user and at least one previous emotion state of at least one previous speech segment of the user; and determining an emotion attention point by a prediction model at least according to the emotion state change of the user.

In a further implementation, the prediction model determines the emotion attention point further according to at least one of: the current emotion state, at least a portion of content of the speech conversation, duration of the current emotion state, topic in the speech conversation, identity of the conversation object, and history emotion records of the user.

In a further implementation, the method further comprises: indicating the emotion attention point in the emotion record; and/or providing a hint to the user at the emotion attention point during the speech conversation.

In addition, the method further comprises: detecting a plurality of speech conversations from one or more of the sound streams; and generating a plurality of emotion records corresponding to the plurality of speech conversation respectively.

In a further implementation, each emotion record of the plurality of emotion records further includes overall emotion state of the user in the speech conversation corresponding to the emotion record. The method further comprises: generating a staged emotion state of the user in each predetermined period of a plurality of predetermined periods, according to at least one overall emotion state of the user included in at least one emotion record in the each predetermined period; and generating emotion statistics of the user in the plurality of predetermined periods according to the staged emotion state of the user in the each predetermined period.

In a further implementation, each emotion record of the plurality of emotion records further includes overall emotion state of the user in the speech conversation corresponding to the emotion record. The method further comprises: generating a staged emotion level of each emotion type of the user in each predetermined period of a plurality of predetermined periods, according to at least one overall emotion state of the user included in at least one emotion record in the each predetermined period; and generating emotion statistics of each emotion type of the user in the plurality of predetermined periods according to the staged emotion level of each emotion type of the user in the each predetermined period.

In a further implementation, the at least one emotion record is associated with identity of a same conversation object.

In addition, the method further comprises: providing the emotion record to the user or a third party.

In addition, the method further comprises: receiving, from the user or the third party, feedback on the emotion record; and updating the emotion record according to the feedback.

It is to be understood that the method 1500 may also include any step/processing for emotion management assistance according to an embodiment of the disclosure, as mentioned above.

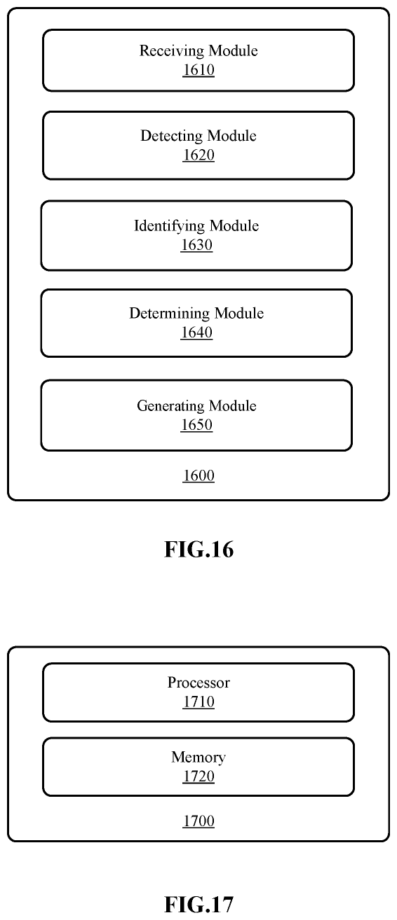

FIG. 16 illustrates an exemplary apparatus 1600 for providing emotion management assistance according to an embodiment.

The apparatus 1600 may comprise: a receiving module 1610, for receiving sound streams; a detecting module 1620, for detecting a speech conversation between a user and at least one conversation object from the sound streams; an identifying module 1630, for identifying identity of the conversation object at least according to speech of the conversation object in the speech conversation; a determining module 1640, for determining emotion state of at least one speech segment of the user in the speech conversation; and a generating module 1650, for generating an emotion record corresponding to the speech conversation, the emotion record at least including the identity of the conversation object, at least a portion of content of the speech conversation, and the emotion state of the at least one speech segment of the user.

In an implementation, the detecting module 1620 is further for: detecting a start point and an end point of the speech conversation at least according to speech of the user and/or speech of the conversation object in the sound streams.

In an implementation, the determining module 1640 is further for: determining emotion state change of the user at least according to current emotion state of current speech segment of the user and at least one previous emotion state of at least one previous speech segment of the user; and determining an emotion attention point by a prediction model at least according to the emotion state change of the user, wherein the emotion attention point is indicated in the emotion record and/or used to provide a hint to the user during the speech conversation.

It should be understood that the apparatus 1600 may also include any other module configured for emotion management assistance according to an embodiment of the disclosure, as mentioned above.

FIG. 17 illustrates another exemplary apparatus 1700 for providing emotion management assistance according to an embodiment. The apparatus 1700 may comprise one or more processors 1710 and a memory 1720 storing computer-executable instructions that, when executed, cause the one or more processors to: receive sound streams; detect a speech conversation between a user and at least one conversation object from the sound streams; identify identity of the conversation object at least according to speech of the conversation object in the speech conversation; determine emotion state of at least one speech segment of the user in the speech conversation; and generate an emotion record corresponding to the speech conversation, the emotion record at least including the identity of the conversation object, at least a portion of content of the speech conversation, and the emotion state of the at least one speech segment of the user.

Embodiments of the present disclosure may be implemented in a non-transitory computer readable medium. The non-transitory computer readable medium may include instructions that, when executed, cause one or more processors to perform any operation of a method for providing emotion management assistance according to an embodiment of the present disclosure as described above.

It should be appreciated that all the operations in the methods described above are merely exemplary, and the present disclosure is not limited to any operations in the methods or sequence orders of these operations, and should cover all other equivalents under the same or similar concepts.

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented as a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout the present disclosure. The functionality of a processor, any portion of a processor, or any combination of processors presented in the present disclosure may be implemented as software being executed by a microprocessor, a microcontroller, DSP, or other suitable platform.

Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout the present disclosure, the memory may be internal to the processors, e.g., cache or register.

The above description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skill in the art are intended to be encompassed by the claims.

1. A method for providing emotion management assistance, comprising:
receiving sound streams;
detecting a speech conversation between a user and at least one conversation object from the sound streams;
identifying identity of the conversation object at least according to speech of the conversation object in the speech conversation;
determining emotion state of at least one speech segment of the user in the speech conversation; and
generating an emotion record corresponding to the speech conversation, the emotion record at least including the identity of the conversation object, at least a portion of content of the speech conversation, and the emotion state of the at least one speech segment of the user.

2. The method of claim 1, wherein emotion state of each speech segment in the at least one speech segment of the user includes emotion type of the speech segment and/or level of the emotion type.

3. The method of claim 1, wherein the detecting the speech conversation comprises:
detecting a start point and an end point of the speech conversation at least according to speech of the user and/or speech of the conversation object in the sound streams.

4. The method of claim 3, wherein the start point and the end point of the speech conversation are detected further according to at least one of: physiological information of the user, environment information of the speech conversation, and background sound in the sound streams.

5. The method of claim 1, wherein the identity of the conversation object is identified further according to at least one of: environment information of the speech conversation, background sound in the sound streams, and at least a portion of content of the speech conversation.

6. The method of claim 1, wherein emotion state of each speech segment in the at least one speech segment of the user is determined according to at least one of: waveform of the speech segment, physiological information of the user corresponding to the speech segment, and environment information corresponding to the speech segment.

7. The method of claim 1, wherein the emotion record further includes at least one of:
keyword/keywords extracted from the speech conversation;
content summary of the speech conversation;
occurrence time of the speech conversation;
occurrence location of the speech conversation;
overall emotion state of the user in the speech conversation;
indication for another conversation of the user associated with the speech conversation; and
emotion suggestion.

8. The method of claim 1, further comprising:
determining emotion state change of the user at least according to current emotion state of current speech segment of the user and at least one previous emotion state of at least one previous speech segment of the user;
determining an emotion attention point by a prediction model at least according to the emotion state change of the user.

9. The method of claim 8, wherein the prediction model determines the emotion attention point further according to at least one of: the current emotion state, at least a portion of content of the speech conversation, duration of the current emotion state, topic in the speech conversation, identity of the conversation object, and history emotion records of the user.

10. The method of claim 8, further comprising:
indicating the emotion attention point in the emotion record; and/or
providing a hint to the user at the emotion attention point during the speech conversation.

11. The method of claim 1, further comprising:
detecting a plurality of speech conversations from one or more of the sound streams; and
generating a plurality of emotion records corresponding to the plurality of speech conversation respectively.

12. The method of claim 11, wherein each emotion record of the plurality of emotion records further includes overall emotion state of the user in a speech conversation corresponding to the emotion record,
the method further comprising:
generating a staged emotion state of the user in each predetermined period of a plurality of predetermined periods, according to at least one overall emotion state of the user included in at least one emotion record in the each predetermined period; and
generating emotion statistics of the user in the plurality of predetermined periods according to the staged emotion state of the user in the each predetermined period.

13. The method of claim 11, wherein each emotion record of the plurality of emotion records further includes overall emotion state of the user in a speech conversation corresponding to the emotion record,
the method further comprising:
generating a staged emotion level of each emotion type of the user in each predetermined period of a plurality of predetermined periods, according to at least one overall emotion state of the user included in at least one emotion record in the each predetermined period; and
generating emotion statistics of each emotion type of the user in the plurality of predetermined periods according to the staged emotion level of each emotion type of the user in the each predetermined period.

14. An apparatus for providing emotion management assistance, comprising:
a receiving module, for receiving sound streams;
a detecting module, for detecting a speech conversation between a user and at least one conversation object from the sound streams;
an identifying module, for identifying identity of the conversation object at least according to speech of the conversation object in the speech conversation;
a determining module, for determining emotion state of at least one speech segment of the user in the speech conversation; and
a generating module, for generating an emotion record corresponding to the speech conversation, the emotion record at least including the identity of the conversation object, at least a portion of content of the speech conversation, and the emotion state of the at least one speech segment of the user.

15. An apparatus for providing emotion management assistance, comprising:
one or more processors; and
a memory storing computer-executable instructions that, when executed, cause the one or more processors to:
receive sound streams;
detect a speech conversation between a user and at least one conversation object from the sound streams;
identify identity of the conversation object at least according to speech of the conversation object in the speech conversation;
determine emotion state of at least one speech segment of the user in the speech conversation; and
generate an emotion record corresponding to the speech conversation, the emotion record at least including the identity of the conversation object, at least a portion of content of the speech conversation, and the emotion state of the at least one speech segment of the user.
